(19) United States
(12) Patent Application Publication
(10) Pub. No.: US 2014/0062691 A1
(43) Pub. Date: Mar. 6, 2014

(54) Hazard Ranger Emergency Signal

(71) Applicant: Keswal Graham, Bronx, NY (US)

(72) Inventor: Keswal Graham, Bronx, NY (US)

(21) Appl. No.: 13/972,831

(22) Filed: Aug. 21, 2013

Related U.S. Application Data
(60) Provisional application No. 61/691,781, filed on Aug. 21, 2012.

(51) Int. Cl. B60Q 7/00

(52) U.S. Cl. CPC B60Q 7/00
USPC 340/473

(57) ABSTRACT

The invention provides a portable illuminated sign comprising flashing directional lights and night signal flare lights to warn other drivers on the road of a parked or disabled vehicle's presence. The Hazard Ranger is comprised of two main components, an illuminated sign and a sturdy support base.

### CLAIM OF PRIORITY

This patent application claims priority under 35 USC 119 (e) (1) from U.S. Provisional Patent Application Ser. No. 61/691,781 filed Aug. 21, 2012, of common inventorship herewith entitled, “Hazard Ranger.”

### FIELD OF THE INVENTION

The present invention pertains to the field of emergency signals, and more specifically to the field of emergency flare and flashing lights.

### BACKGROUND OF THE INVENTION

The prior art has put forth several designs for emergency signals. Among these are:

U.S. Pat. No. 5,831,522 to Leonard E. Weed, Ronald J. Weed and Dwight V. Call describes a portable visual emergency signal device for generally indicating caution and for providing a beacon to guide emergency vehicles or personnel to an emergency site. The emergency signal device is sectioned into a plurality of wedges, each wedge having a translucent faceted face and a distinct color. The emergency signal device also contains a plurality of sequentially fired lamps and at least one reflective surface cooperating with the lamps to facilitate propagation of light energy. The emergency signal device further includes a battery and an alarm cooperating with the battery to indicate a low battery.

U.S. Pat. No. 6,963,275 to Bryan H. Smalls describes a flashing warning light apparatus for warning motorists in oncoming traffic that an object such as a car is stopped near the highway ahead. The apparatus includes a housing with an array of lights on the front and possibly also the rear faces. Sensors front and back sense oncoming traffic. A switch allows the user to cause the arrays of lights to flash continuously or only when oncoming traffic is sensed. The device may be powered by the car battery through a cigarette lighter adapter, dry cell batteries or a solar cell.

US Patent 2006/0162643 to A. L. Pepper Aasgaard describes an emergency signaling device comprising a flexible substrate stowed in the trunk of a vehicle for extending from a folded position to an extended position, for conveying a message to motorists approaching the vehicle. The emergency signaling device may extend from the trunk of the vehicle upon activation of a remote trunk release when a hazard flasher system is on. The emergency signaling device may be removed from the vehicle for use as an emergency signaling device.

None of these prior art references describe the present invention.

### SUMMARY OF THE INVENTION

It is an object of the present invention to provide a portable illuminated emergency sign with flashing directional lights and night signal flare lights.

### BRIEF DESCRIPTION OF THE DRAWINGS

FIG. 1 is a perspective diagonal front view showing flashing signal lights, a switch panel, a cigar lighter, a cap, additional outlet connections and a place for additional functions.

FIG. 2 is a perspective front view showing a night signal flare, a hook holder, LED lights, adjustable tubing and a reserve battery.

FIG. 3 is a perspective front view highlighting a battery compartment, an adjustable head and a flex head pin adjuster.

FIG. 4 is a perspective top view showing a battery compartment on back, and a water or sand fill on base.

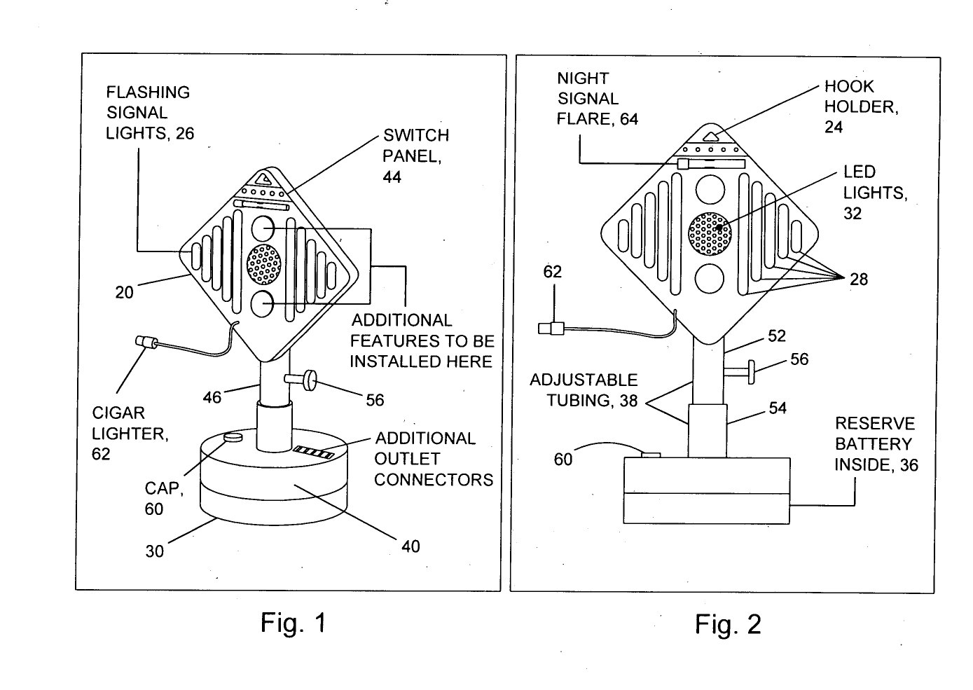

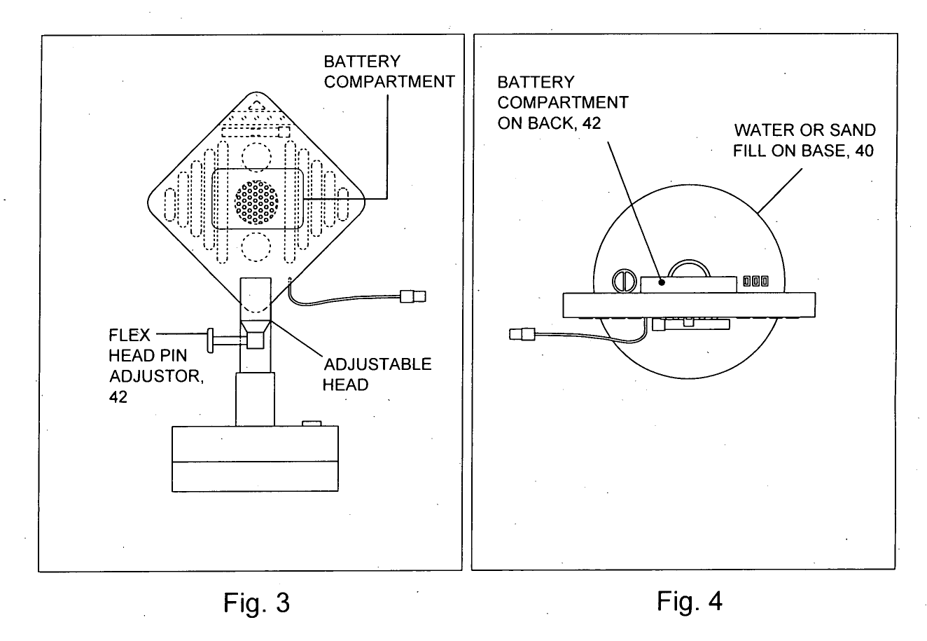

### DETAILED DESCRIPTION OF THE INVENTION

The present invention, hereinafter referred to as The Hazard Ranger, is a portable illuminated sign comprising flashing directional lights and night signal flare lights. Employed in the event of a vehicle break down or accident, the object of the Hazard Ranger is to warn other drivers on the road of a parked or disabled vehicle's presence, allowing those drivers to slow and seek help for the stranded driver. Hazard Ranger also is utilized by outdoor enthusiasts such as campers, hikers and boaters as a means of alerting others in an emergency situation.

The Hazard Ranger is comprised of two main components, an illuminated sign 20 and a sturdy support base 30. The sign 20 is manufactured of weather resistant shatterproof plastic material. The electronic components are housed within this sign 20. The sign 20 comprises a distinct diamond shape with each of its four sides measuring approximately twelve inches in length. The sign 20 measures approximately one and one half inches in depth. A sturdy hanging hook holder 24 is positioned at the top of the sign for suspending it from any number of objects. Positioned in rows across the top of the sign are a series of highly visible night signal flare lights 26. Positioned on either side of the sign and facing outwards are two directional arrows with each arrow comprised of vertical rows of lights 28 that extend to the angled outer corners of the sign. These arrows 28 operate independently of one another, so a user can activate a designated arrow to alert motorists about which direction to follow in passing around a disabled vehicle. These arrows 28 are activated together to display a universal hazard signal. A circular panel of flare lights 32 is located in the center of the sign. Contrasting colors are utilized on the sign. The signal lights 26 are yellow while the flare lights 32 are orange or red. These lights are comprised of shatterproof Light Emitting Diode or LED light bulbs.

Operational controls 44 for operating the various sets of light are mounted on the front of the sign near the top of the sign. A horizontal night signal flare 64 is mounted at the top of the sign.

An elongated adapter cord mounted on the back of the sign is used for plugging the Hazard Ranger into any vehicle cigarette lighter or electrical outlet. This adapter also is connectable to the sign's internal reserve battery 36 that is housed in the base of the sign. The sign's base 30 is comprised of a circular shaped platform on which an adjustable vertical tubing support post 38 is mounted. Housed within this base platform is a watertight compartment 32 for a rechargeable battery. The remainder 40 of the base is hollow and may be filled with sand or water to add weight and stability to the sign during use. A cap 60 accesses the hollow compartment 40 of the base.

Additionally, a cigar or cigarette lighter 62 is provided for convenience.

The support post 46 is comprised of lightweight hollow tubing 38 assembled in telescoping sections with each section being marginally smaller in diameter than a lower adjacent section in which it is inserted. One or more sturdy adjustment knobs 56 are appropriately positioned along the support post to secure the sign to a desired height. The post 46 is extendable to several feet in height. An adjustable male fitting 52 located at the base of the sign is inserted into a female fitting 54 mounted at the top of the sign's base 30. A flex head adjuster pin 42 is included for the angle of the attached sign as desired.

The Hazard Ranger provides drivers with an effective means of alerting other motorists that their vehicle is stranded on a roadside and they are in need of assistance. Cautioning passing traffic to reduce speed and veer to the right or left to avoid the disabled or parked vehicle, the Hazard Ranger alerts others to a potentially dangerous situation day or night. Not limited to use by motorists, the Hazard Ranger is an invaluable commodity to any outdoor enthusiast. Packed along with boating gear, the present invention is a useful aide for boaters who are stranded miles from shore. Campers and hikers employ the Hazard Ranger if they become lost in the woods and need to call for help. Emitting a brilliant flashing beacon of light, the present invention provides a highly visible alert to enable rescue personnel to quickly locate a stranded individual and offer immediate assistance. Weather resistant and durably constructed, the Hazard Ranger will withstand years of reliable use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A portable illuminated emergency sign device with flashing directional lights and night signal flare lights, comprising: an illuminated sign and a sturdy support base, wherein the sign is manufactured of weather resistant shatterproof plastic material and Wherein electronic components are housed within the sign, and wherein the sign comprises a diamond shape having four sides.

2. The portable illuminated emergency sign device of claim 1 with each of its four sides measuring approximately twelve inches in length and wherein the sign measures approximately one and one half inches in depth.

3. The portable illuminated emergency sign device of claim 1 further comprising a sturdy hanging hook holder positioned at the top of the sign for suspending it from any number of objects.

4. The portable illuminated emergency sign device of claim 1 further comprising a series of highly visible night signal flare lights positioned in a row across the top of the sign.

5. The portable illuminated emergency sign device of claim 1 further comprising two directional arrows with each arrow comprised of a vertical row of lights that extend to the outer corner of the sign, wherein the vertical row of lights is positioned on each side of the sign and facing outwards.

6. The portable illuminated emergency sign device of claim 5 wherein the arrows operate independently of one another, so a user can activate a designated arrow to alert motorists about which direction to follow in passing around a disabled vehicle.

7. The portable illuminated emergency sign device of claim 5 wherein the arrows are activated together to display a universal hazard signal.

8. The portable illuminated emergency sign device of claim 1 further comprising a circular panel of flare lights located in the center of the sign.

9. The portable illuminated emergency sign device of claim 1 further comprising contrasting colors.

10. The portable illuminated emergency sign device of claim 9 wherein the signal lights are yellow and flare lights are orange or red.

11. The portable illuminated emergency sign device of claim 9 wherein the lights are comprised of shatterproof Light Emitting Diode or LED light bulbs.

12. The portable illuminated emergency sign device of claim 1 further comprising operational controls are mounted on the front of the sign near the top of the sign.

13. The portable illuminated emergency sign device of claim 1 further comprising an elongated adapter cord mounted on the back of the sign used for plugging the device into any vehicle cigarette lighter or electrical outlet.

14. The portable illuminated emergency sign device of claim 13 wherein the adapter also is connectable to an internal reserve battery that is housed in the base of the sign.

15. The portable illuminated emergency sign device of claim 1 wherein the base is comprised of a circular shaped platform on which an adjustable vertical tubing support post is mounted.

16. The portable illuminated emergency sign device of claim 15 wherein the base a watertight compartment for receiving a rechargeable battery.

17. The portable illuminated emergency sign device of claim 15 wherein the base further comprises a hollow compartment which can be filled with sand or water to add weight and stability to the sign during use.

18. The portable illuminated emergency sign device of claim 17 wherein the base further comprises a cap to access the hollow compartment of the base.

19. The portable illuminated emergency sign device of claim 1 further comprising a cigar or cigarette lighter.

20. The portable illuminated emergency sign device of claim 1 wherein the support base is comprised of lightweight hollow tubing assembled in telescoping sections with each section being smaller in diameter than a lower adjacent section in which it is inserted.
